(19) United States
(12) Patent Application Publication
(10) Pub. No.: US 2026/0071453 A1
(43) Pub. Date: Mar. 12, 2026

(54) Swimming Pool Backwash Filtration Device

(71) Applicant: Alexander Tothfalusi, Mount Brydges (CA)

(72) Inventor: Alexander Tothfalusi, Mount Brydges (CA)

(21) Appl. No.: 19/393,044

(22) Filed: Nov. 18, 2025

Related U.S. Application Data
(63) Continuation-in-part of application No. 18/201,247, filed on May 24, 2023.
Application No. 18/201,247 is a continuation-in-part of application No. 17/742,555, filed on May 12, 2022, now abandoned.

(51) Int. Cl. E04H 4/12; B01D 35/30

(52) U.S. Cl. CPC E04H 4/1209; B01D 35/30; B01D 2201/303; B01D 2201/306

(57) ABSTRACT

A pool backwash secondary filtration device includes a housing, a first end cap, and a second end cap. A first end channel through the first end cap and a second end channel through the second end cap are in fluid communication with an interior space of the housing. A filter is positioned within the interior space extending between a primary end of the filter and a secondary end of the filter. The primary end is closed and spaced from the first end channel. The secondary end is coupled to the second end cap for water to be passed through the filter. The first end cap couples to a hose from a main pool filter of a pool such that the housing is downstream from the main pool filter. The second end cap couples to a return hose in fluid communication with the pool.

### CROSS-REFERENCE TO RELATED APPLICATIONS

This application is a continuation in part of application Ser. No. 18/201,247 filed May 24, 2023, which was a continuation in part of application Ser. No. 17/742,555 filed May 12, 2022.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to filtration devices and more particularly pertains to a new filtration device for filtering water from a pool for reuse. Primary filtration assemblies for filtering pool water often fail to remove fine particulates.

### (2) Description of Related Art Including Information Disclosed Under 37 CFR 1.97 and 1.98

The prior art relates to filtration devices. While primary filtration assemblies for filtering pool water are known in the prior art, the prior art does not teach a secondary filtration assembly configured to fine filter the backwash from a swimming pool, thus recycling the pool water for further use.

### BRIEF SUMMARY OF THE INVENTION

An embodiment of the disclosure meets the needs presented above by generally comprising a housing, a first end cap, and a second end cap. A first end channel through the first end cap and a second end channel through the second end cap are in fluid communication with an interior space of the housing. A filter is positioned within the interior space extending between a primary end of the filter and a secondary end of the filter. The primary end is closed and spaced from the first end channel. The secondary end is coupled to the second end cap for water to be passed through the filter. The first end cap couples to a hose from a main pool filter of a pool such that the housing is downstream from the main pool filter. The second end cap couples to a return hose in fluid communication with the pool.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a pool backwash secondary filtration device according to an embodiment of the disclosure.

FIG. 2 is a top front perspective view of an embodiment of the disclosure.

FIG. 3 is a side view of an embodiment of the disclosure.

FIG. 4 is an exploded side view of an embodiment of the disclosure.

FIG. 5 is a cross-sectional view of an embodiment of the disclosure taken along line 5-5 of FIG. 3.

FIG. 6 is a top perspective view of a first end cap of an embodiment of the disclosure.

FIG. 7 is a bottom perspective view of a first end cap of an embodiment of the disclosure.

FIG. 8 is a top perspective view of a second end cap of an embodiment of the disclosure.

FIG. 9 is a bottom perspective view of a second end cap of an embodiment of the disclosure.

FIG. 10 is a top perspective view of a first end plug of an embodiment of the disclosure.

FIG. 11 is a bottom perspective view of a first end plug of an embodiment of the disclosure.

FIG. 12 is a top perspective view of a second end plug of an embodiment of the disclosure.

FIG. 13 is a top view of a diverter of an embodiment of the disclosure.

FIG. 14 is a schematic view of an embodiment of the disclosure.

FIG. 15 is a cross-sectional view taken along line 15-15 of FIG. 6.

FIG. 16 is a cross-sectional view taken along line 16-16 of FIG. 7.

FIG. 17 is a cross-sectional view of an embodiment of the disclosure taken perpendicular to a longitudinal axis of a housing.

### DETAILED DESCRIPTION OF THE INVENTION

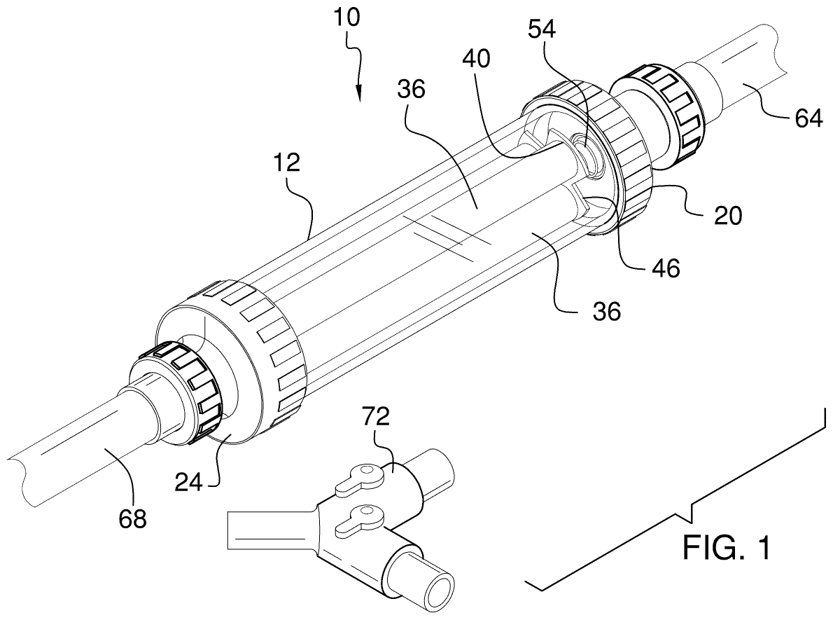

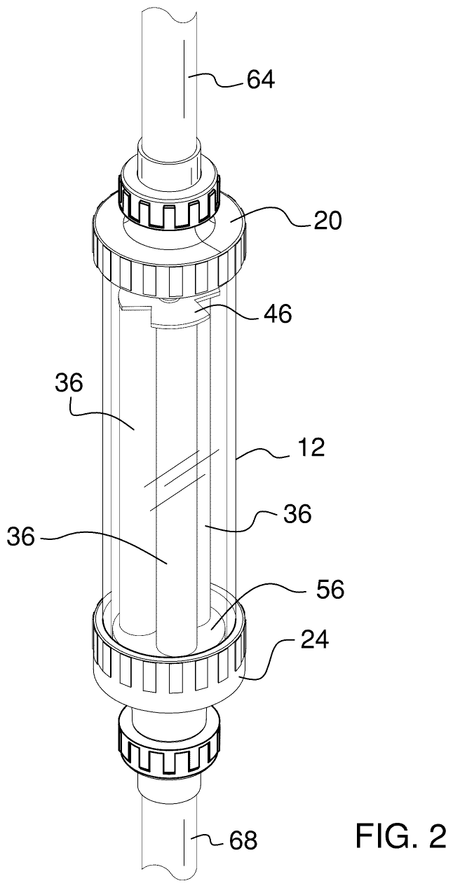

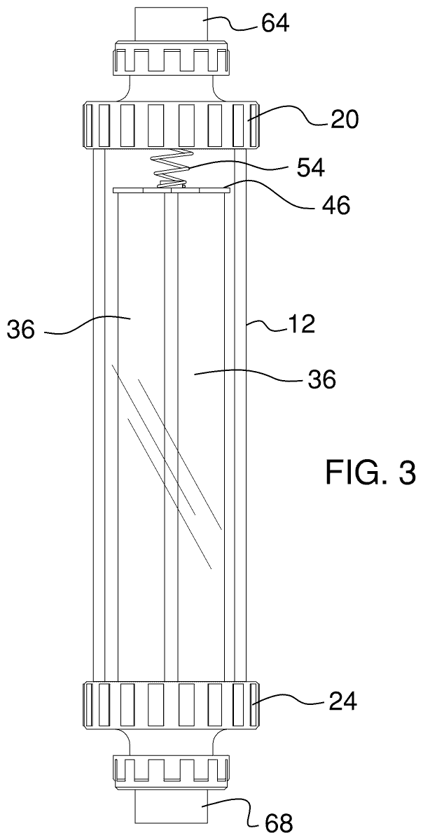

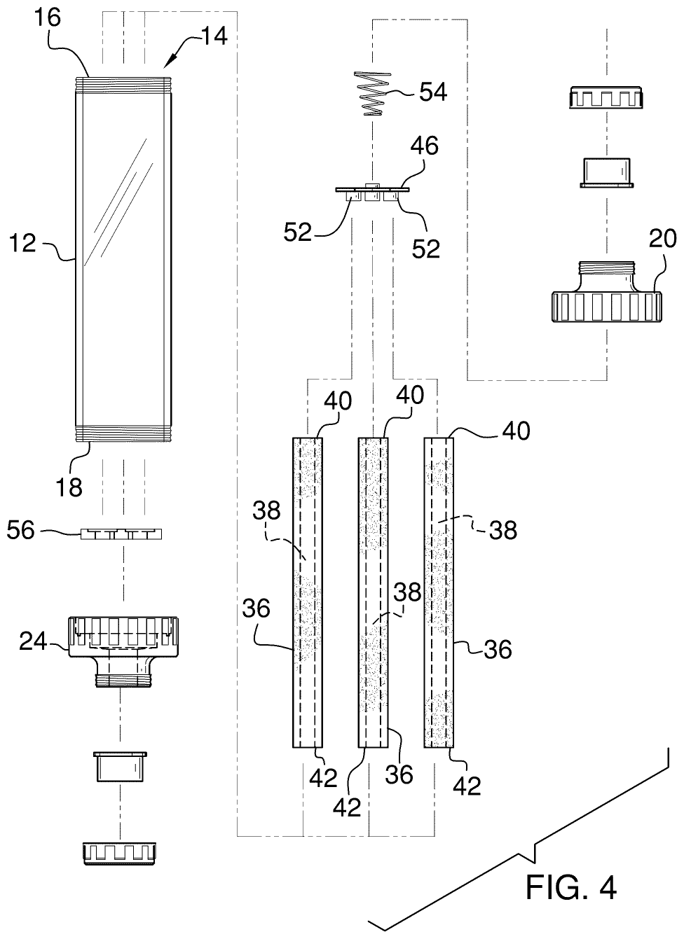

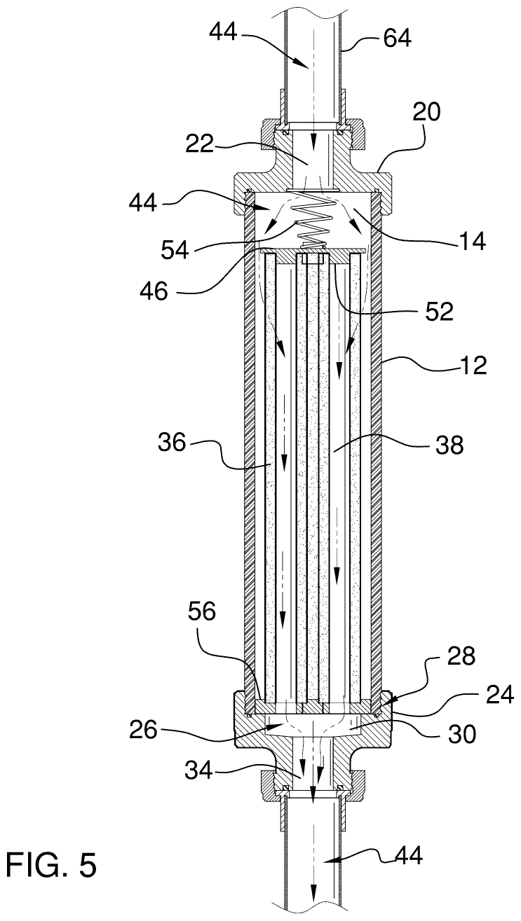

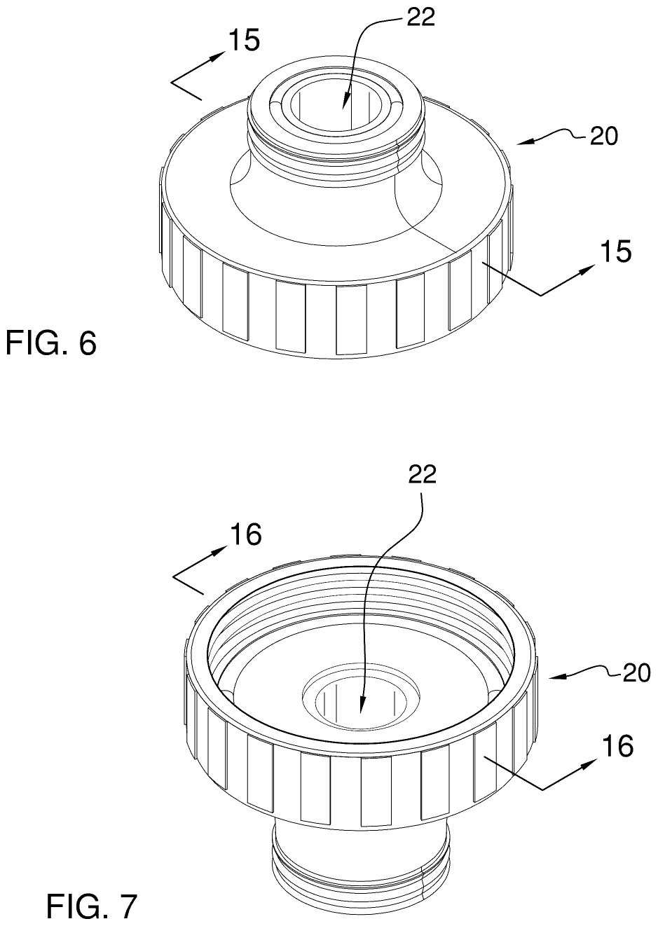

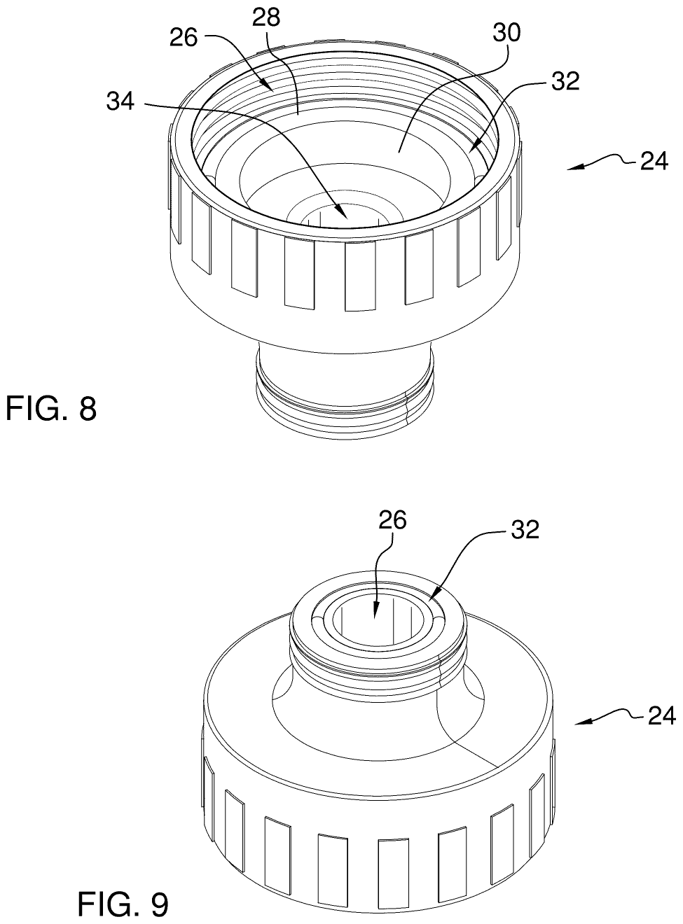

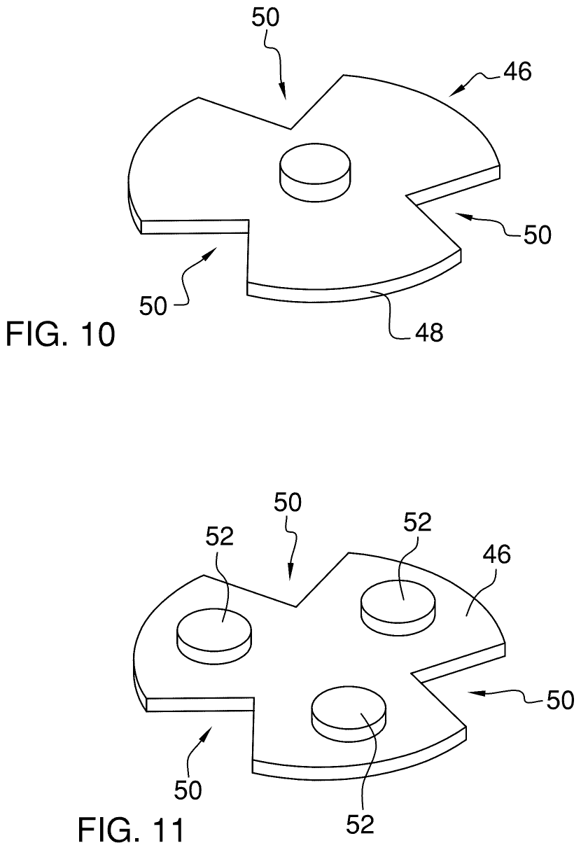

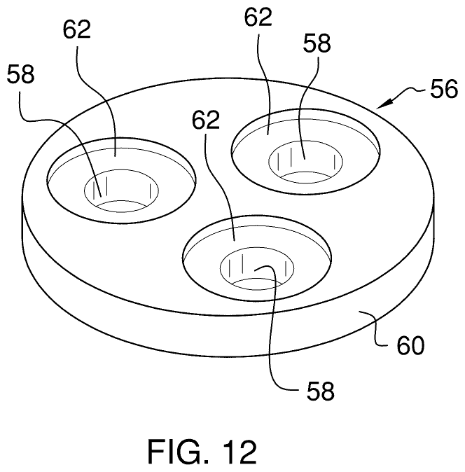

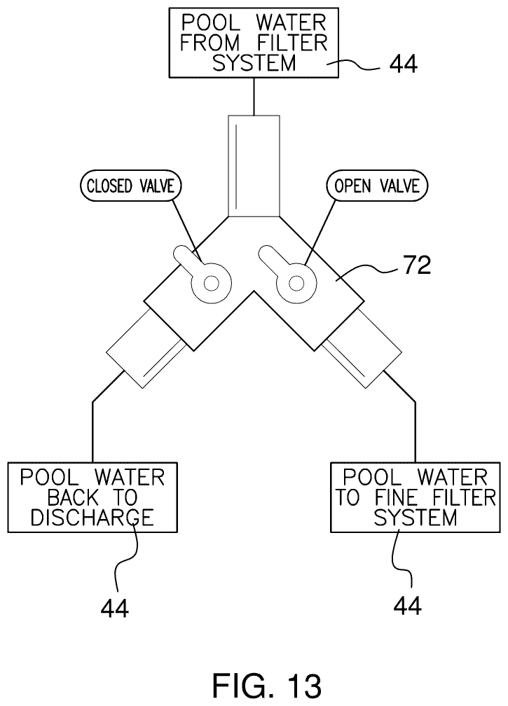

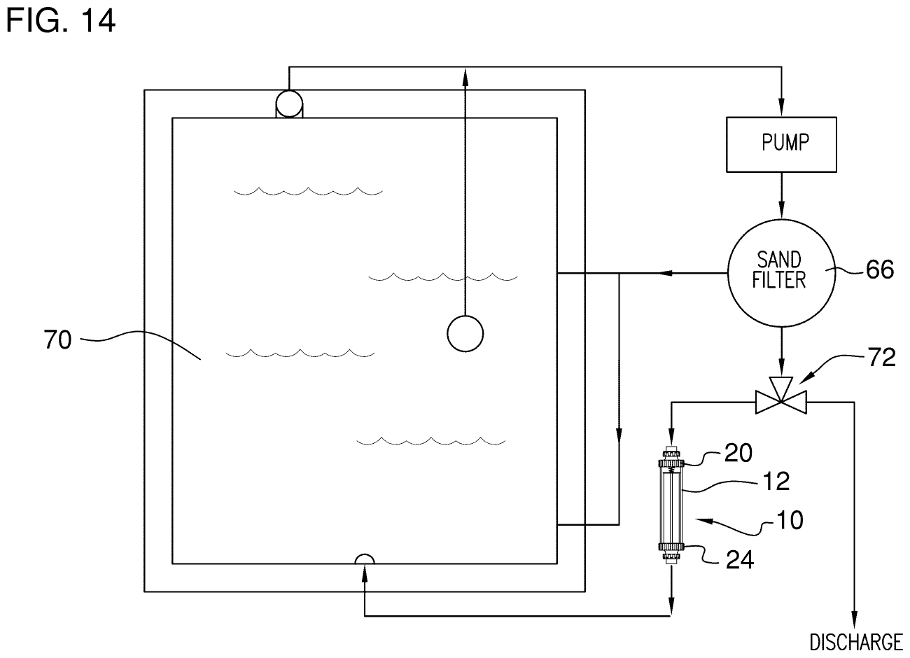

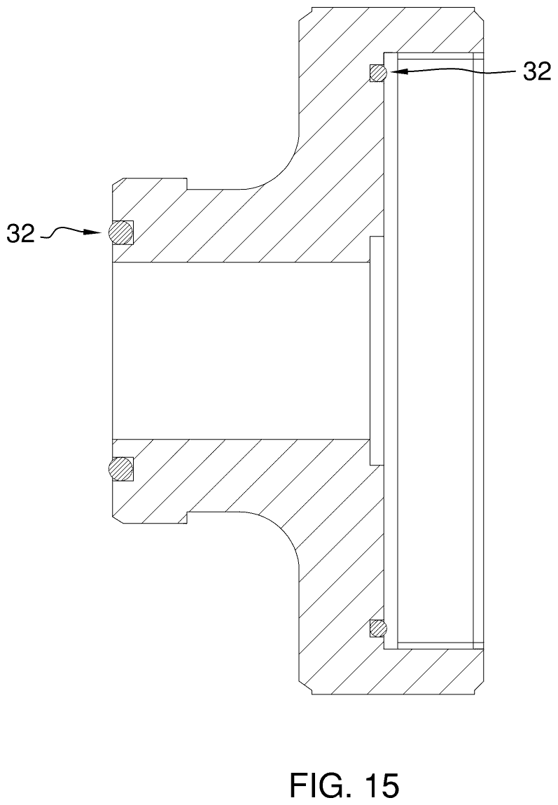

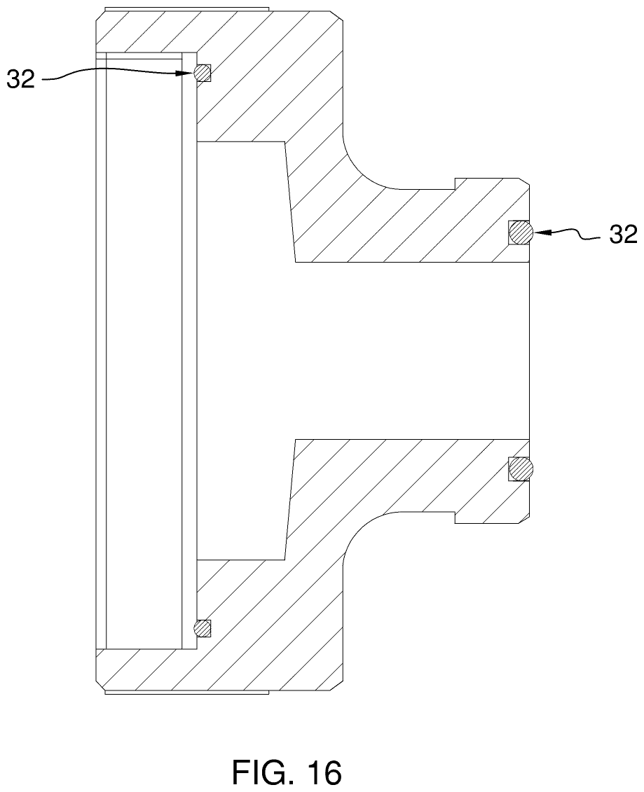

With reference now to the drawings, and in particular to FIGS. 1 through 17 thereof, a new filtration device embodying the principles and concepts of an embodiment of the disclosure and generally designated by the reference numeral 10 will be described.

As best illustrated in FIGS. 1 through 17, the pool backwash secondary filtration device 10 generally comprises a housing 12 defining an interior space 14. The housing 12 is cylindrical and has a first end 16 and a second end 18. The first end 16 and the second end 18 are open. A first end cap 20 is sealingly coupled to the first end 16 of the housing 12. A first end channel 22 extends through the first end cap 20. The first end channel 22 is in fluid communication with the interior space 14. A second end cap 24 is sealingly coupled to the second end 18 of the housing 12. A second end channel 26 extends through the second end cap 24. The second end channel 26 is in fluid communication with the interior space 14. The second end channel 26 has a socket section 28 and a medial section 30. Each of the first end cap 20 and the second end cap 24 are threadedly engageable to the housing 12 consistent with the structure as shown in the drawing figures and may include O-ring seals 32 in a conventional manner. The second end channel 26 further has a terminal section 34 extending from the medial section 30. The terminal section 34 has a diameter less than a diameter of the medial section 30.

Each of a plurality of filters 36 is positioned within the interior space 14. Each filter 36 is tubular defining an interior filter conduit 38 extending between a primary end 40 of the filter 36 and a secondary end 42 of the filter 36. The primary end 40 of each filter 36 is closed, as described more fully below, and spaced from the first end channel 22. The secondary end 42 of each filter 36 is sealingly coupled to the second end cap 24 as described further below. Thus, each filter 36 is configured for water 44 passing into the interior space 14 from the first end channel 22 to be passed through one of the filters 36 before being passed into the second end channel 26. The medial section 30 is in direct fluid communication with the secondary end 42 of each of the filters 36 as further described below.

A first end plug 46 is coupled to the primary end 40 of each of the filters 36. The first end plug 46 closes the primary end 40 of each of the filters 36. An outer peripheral edge 48 of the first end plug 46 has indentations 50 wherein the first end plug 46 is configured for water 44 within the interior space 14 to pass through the indentations 50. The first end plug 46 has a plurality of cylindrical extensions 52. Each cylindrical extension 52 is insertable into the primary end 40 of a respective one of the filters 36 such that the cylindrical extension 52 closes the primary end 40 of the respective one of the filters 36 and engages the respective one of the filters 36 to the first end plug 46. A biaser 54 is positioned within the interior space 14. The biaser 54 is positioned between the first end cap 20 and the first end plug 46 such that the first end plug 46 is spaced from the first end cap 20. Thus, the biaser 54 urges the first end plug 46 away from the first end cap 20.

A second end plug 56 is coupled to the secondary end 42 of each of the filters 36. The second end plug 56 has a plurality of apertures 58. Each aperture 58 is aligned with a respective one of the filters 36 wherein each of the apertures 58 is configured to pass water 44 from the respective one of the filters 36 to the second end channel 26. An outer edge 60 of the second end plug 56 is sealingly engaged to the second end cap 24. The second end plug 56 has a plurality of seats 62 extending into the second end plug 56. Each aperture 58 is aligned and in fluid communication with a respective one of the seats 62. Each of the seats 62 receives the secondary end 42 of a respective one of the filters 36. The socket section 28 receives the second end 18 of the housing 12 and the second end plug 56.

The first end cap 20 is configured for coupling to a hose 64 from a main pool filter 66 in a conventional manner such that the housing 12 is downstream from the main pool filter 66. The second end cap 24 is configured for coupling in a conventional manner to a return hose 68 in fluid communication with a pool 70.

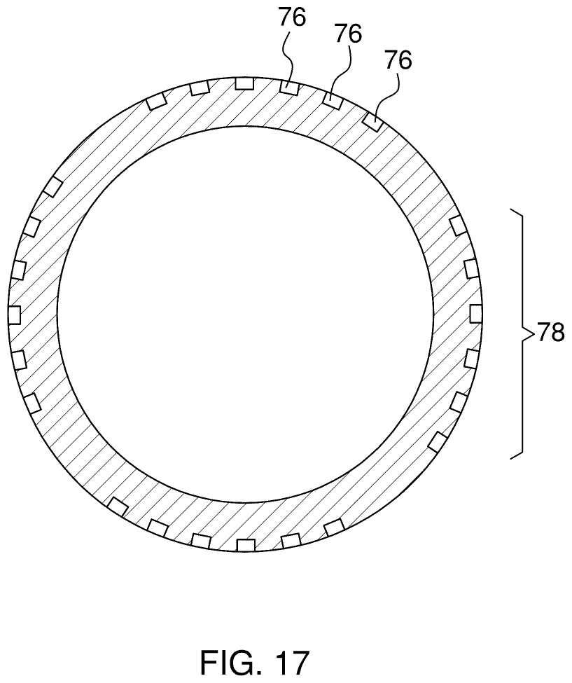

As shown in FIG. 17, the housing 12 may have grooves 76 extending parallel to a longitudinal axis of the housing 12. The grooves 76 can be grouped to define ridge sections 78 arranged radially around the housing 12 to facilitate grasping of the housing 12.

In use, the device 10 may be installed using a diverter 72 allowing for secondary filtration of water 44 returned to the pool 70, or to bypass secondary filtration if desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pool backwash secondary filtration device:
a housing defining an interior space, the housing being cylindrical and having a first end and a second end, the first end being open, the second end being open;
a first end cap sealingly coupled to said first end of said housing, a first end channel extending through said first end cap, said first end channel being in fluid communication with said interior space;
a second end cap sealingly coupled to said second end of said housing, a second end channel extending through said second end cap, said second end channel being in fluid communication with said interior space;
a filter being positioned within said interior space, said filter being tubular defining an interior filter conduit extending between a primary end of said filter and a secondary end of said filter, said primary end being closed and spaced from said first end channel, said secondary end being sealingly coupled to said second end cap wherein said filter is configured for water passing into said interior space from said first end channel to be passed through said filter before being passed into said second end channel;
wherein said first end cap is configured for coupling to a hose from a main pool filter such that said housing is downstream from the main pool filter; and
wherein said second end cap is configured for coupling to a return hose in fluid communication with the pool.

2. A pool backwash secondary filtration device:
a housing defining an interior space, the housing being cylindrical and having a first end and a second end, the first end being open, the second end being open;
a first end cap sealingly coupled to said first end of said housing, a first end channel extending through said first end cap, said first end channel being in fluid communication with said interior space;
a second end cap sealingly coupled to said second end of said housing, a second end channel extending through said second end cap, said second end channel being in fluid communication with said interior space;
a plurality of filters, each filter being positioned within said interior space, each said filter being tubular defining an interior filter conduit extending between a primary end of said filter and a secondary end of said filter, said primary end of each said filter being closed and spaced from said first end channel, said secondary end of each said filter being sealingly coupled to said second end cap wherein each said filter is configured for water passing into said interior space from said first end channel to be passed through one of said filters before being passed into said second end channel;
wherein said first end cap is configured for coupling to a hose from a main pool filter such that said housing is downstream from the main pool filter; and
wherein said second end cap is configured for coupling to a return hose in fluid communication with the pool.

3. The pool backwash secondary filtration device of claim 2, further comprising a first end plug coupled to said primary end of each of said filters, said first end plug closing said primary end of each of said filters.

4. The pool backwash secondary filtration device of claim 3, a second end plug coupled to said secondary end of each of said filters, said second end plug having a plurality of apertures, each aperture being aligned with a respective one of said filters wherein each of said apertures is configured to pass water from said respective one of said filters to said second end channel.

5. The pool backwash secondary filtration device of claim 3, further comprising an outer peripheral edge of said first end plug having indentations wherein said first end plug is configured for water to pass through said indentations.

6. The pool backwash secondary filtration device of claim 4, further comprising an outer edge of said second end plug being sealingly engaged to said second end cap.

7. The pool backwash secondary filtration device of claim 6, further comprising said second end channel having a socket section, said socket section receiving said second end of said housing and said second end plug.

8. The pool backwash secondary filtration device of claim 7, further comprising:
said second end channel having a medial section, said medial section being in fluid communication with said secondary end of each of said filters; and
said second end channel having a terminal section extending from said medial section, said terminal section having a diameter less than a diameter of said medial section.

9. The pool backwash secondary filtration device of claim 3, further comprising a biaser positioned within said interior space, said biaser being positioned between said first end cap and said first end plug such that said first end plug is spaced from said first end cap and whereby said biaser urges said first end plug away from said first end cap.

10. The pool backwash secondary filtration device of claim 2, wherein said plurality of filters is three filters.

11. The pool backwash secondary filtration device of claim 3, further comprising said first end plug having a plurality of cylindrical extensions, each cylindrical extension being insertable into said primary end of a respective one of said filters such that said cylindrical extension closes said primary end of said respective one of said filters and engages said respective one of said filters to said first end plug.

12. The pool backwash secondary filtration device of claim 1, further comprising each of said first end cap and said second end cap being threadedly engageable to said housing.

13. The pool backwash secondary filtration device of claim 4, further comprising said second end plug having a plurality of seats extending into said second end plug, each apertures being aligned and in fluid communication with a respective one of said seats, each of said seats receiving said secondary end of a respective one of said filters.

14. A pool backwash secondary filtration device:
a housing defining an interior space, the housing being cylindrical and having a first end and a second end, the first end being open, the second end being open;
a first end cap sealingly coupled to said first end of said housing, a first end channel extending through said first end cap, said first end channel being in fluid communication with said interior space;
a second end cap sealingly coupled to said second end of said housing, a second end channel extending through said second end cap, said second end channel being in fluid communication with said interior space, said second end channel having a socket section, said second end channel having a medial section, each of said first end cap and said second end cap being threadedly engageable to said housing;
said second end channel having a terminal section extending from said medial section, said terminal section having a diameter less than a diameter of said medial section;
a plurality of filters, each filter being positioned within said interior space, each said filter being tubular defining an interior filter conduit extending between a primary end of said filter and a secondary end of said filter, said primary end of each said filter being closed and spaced from said first end channel, said secondary end of each said filter being sealingly coupled to said second end cap wherein each said filter is configured for water passing into said interior space from said first end channel to be passed through one of said filters before being passed into said second end channel, said medial section being in fluid communication with said secondary end of each of said filters;
a first end plug coupled to said primary end of each of said filters, said first end plug closing said primary end of each of said filters, an outer peripheral edge of said first end plug having indentations wherein said first end plug is configured for water within said interior space to pass through said indentations;
said first end plug having a plurality of cylindrical extensions, each cylindrical extension being insertable into said primary end of a respective one of said filters such that said cylindrical extension closes said primary end of said respective one of said filters and engages said respective one of said filters to said first end plug;
a biaser positioned within said interior space, said biaser being positioned between said first end cap and said first end plug such that said first end plug is spaced from said first end cap and whereby said biaser urges said first end plug away from said first end cap;
a second end plug coupled to said secondary end of each of said filters, said second end plug having a plurality of apertures, each aperture being aligned with a respective one of said filters wherein each of said apertures is configured to pass water from said respective one of said filters to said second end channel, an outer edge of said second end plug being sealingly engaged to said second end cap;
said second end plug having a plurality of seats extending into said second end plug, each apertures being aligned and in fluid communication with a respective one of said seats, each of said seats receiving said secondary end of a respective one of said filters
said socket section receiving said second end of said housing and said second end plug
wherein said first end cap is configured for coupling to a hose from a main pool filter such that said housing is downstream from the main pool filter; and
wherein said second end cap is configured for coupling to a return hose in fluid communication with the pool.

15. The pool backwash secondary filtration device of claim 14, wherein said plurality of filters is three filters.
